(19) United States
(12) Patent Application Publication
(10) Pub. No.: US 2012/0223255 A1
(43) Pub. Date: Sep. 6, 2012

(54) PRECISION APPROACH PATH INDICATOR

(75) Inventor: Duncan John William Walker, Surrey (GB)

(73) Assignee: AERONAUTICAL & GENERAL INSTRUMENTS LIMITED, Dorset (GB)

(21) Appl. No.: 13/408,688

(22) Filed: Feb. 29, 2012

Related U.S. Application Data
(60) Provisional application No. 61/500,705, filed on Jun. 24, 2011.

(30) Foreign Application Priority Data
Mar. 4, 2011 (GB) 1103731.4

(51) Int. Cl. B64F 1/18

(52) U.S. Cl. 250/495.1; 362/559; 362/555

(57) ABSTRACT

A Precision Approach Path Indicator (PAPI) unit comprises first and second light sources and a projection lens assembly. Light emitted by the first and second light sources is collected by first and second solid waveguides respectively and is guided by said waveguides to an intermediate plane. The intermediate plane is located in the focal plane of the projection lens assembly.

### CROSS REFERENCE TO RELATED APPLICATIONS

This application claims priority from U.S. Provisional Patent Application No. 60/500,705 filed on Jun. 24, 2011 and claims priority from United Kingdom Patent Application No. 1103731.4 filed on Mar. 4, 2011, both of which are incorporated herein in their entirety by reference.

### TECHNICAL FIELD

This invention relates in general to a visual navigational aid, and in particular to a Precision Approach Path Indicator (PAPI) system.

### BACKGROUND

Precision Approach Path Indicator (PAPI) systems are used to assist the pilot of an aircraft on a landing approach to an airfield. In particular, the PAPI provides a visual indication of the correct glide slope. Typically, a PAPI system comprises four units that are positioned in a row alongside and perpendicular to the runway. Each unit transmits a beam of light that has two differently-colored components, referred to as sectors, typically white above the horizontal center line and red below. Two of the units are directed at an angle slightly greater than the optimum approach angle, and two of the units are directed at an angle that is slightly lower than the optimum approach angle. A pilot on the correct glide slope will see two red beams and two white beams. If the approach path is too steep, the beams all appear white; if the approach path is too low, the beams all appear red. Thus, the pilot is able to adjust the aircraft's altitude in order to maintain the desired combination of red and white beams, thereby optimizing the angle of approach to landing. In certain circumstances, the use of a so-called “abbreviated” PAPI may be permitted, comprising just two units, but the principle of operation is the same as that of the normal, four-unit PAPI.

Authorities such as the Federal Aviation Authority (FAA) and International Civil Aviation Organization (ICAO) apply strict standards to PAPI systems, imposing stringent requirements on such parameters as the dimensions and intensity of the transmitted light beams, and most importantly on the angular range over which the transition from white to red occurs.

Conventional PAPI systems have used incandescent light sources, or in some cases fluorescent or arc lamps. Such lamp-based systems suffer, however, from numerous disadvantages. Notable amongst these are the relatively short life span of the lamps, as well inefficient energy usage.

More recently, PAPI systems using light emitting diode (LED) light sources have been proposed. However, the use of such light sources is also not without problems. In particular, LED light sources emit light over a considerable range of angles and efficient collimation of the light into an effective beam is difficult. In consequence, there is an ongoing need for improved PAPI systems, in particular those based on LED or other non-incandescent light sources.

### SUMMARY

There has now been devised an improved PAPI system which addresses the above-mentioned and/or other disadvantages associated with the prior art.

According to a first aspect of the invention, there is provided a Precision Approach Path Indicator (PAPI) unit, said unit comprising first and second light sources and a projection lens assembly, wherein light emitted by the first and second light sources is collected by first and second solid waveguides respectively and is guided by said waveguides to an intermediate plane, said intermediate plane being located in the focal plane of the projection lens assembly.

In a further aspect of the invention, there is provided a Precision Approach Path Indicator (PAPI) system comprising a plurality of PAPI units according to the first aspect of the invention.

In the PAPI unit and system according to the invention, solid waveguides are used to channel light emitted by the light sources to an intermediate plane. The intermediate plane coincides with the focal plane of the projection lens assembly, which transmits the image formed at the intermediate plane into the far field, transforming position in the intermediate plane into angle in the far field. The use of solid waveguides to collect and channel light to the intermediate plane significantly reduces alignment tolerances of the light sources and associated optical components, greatly simplifying manufacture. The units are also easier to maintain, as they require little or no critical optical setup, so reducing downtime and leading to time and cost savings.

The dimensions of the waveguides may be such that their distal ends lie in the intermediate plane, i.e., the image at the intermediate plane that is projected into the far field by the projection lens assembly may be the image at the distal ends of the waveguides. In alternative embodiments, the intermediate plane may lie beyond the distal ends of the waveguides. In the latter case, it will generally be necessary for the light beams from the first and second light sources to be kept apart between the waveguides and the intermediate plane, e.g. by means of a physical partition.

As is conventional, the PAPI unit of the invention includes first and second light sources, corresponding to the two sectors that are fundamental to the operation of a PAPI system. The two sectors are visually distinguishable. In a PAPI system intended for conventional operation, the first and second light sources will emit differently colored light, e.g. red and white light. The first and second light sources may be light sources that emit differently colored light, or they may be similar or identical light sources, e.g. that emit white light, light from one or both being passed through a filter to create a visually distinguishable color difference between the two sectors. For the avoidance of doubt, it should be made clear that more than two light sources may be employed, though for the operation of a conventional PAPI system it is only two light sources that are required.

Other forms of differentiation between the two sectors may also be employed. For instance, the light sources in one sector may emit continuously, while those in the other are intermittent. Such an arrangement may be useful in a PAPI system intended for night use, wherein the light sources are infra-red and are visualized using night vision equipment.

The light sources used in the PAPI unit of the invention are preferably non-incandescent light sources. Most preferably, the light sources are light emitting diodes (LEDs), and most commonly each light source will comprise a plurality of LEDs. The number of LEDs in each light source is not critical, but the first light source most preferably comprises a plurality of red light-emitting diodes, e.g. 2 to 10, or 4 to 8, such LEDs. Similarly, the second light source most preferably comprises a plurality of white light-emitting diodes, e.g. 2 to 10, or 4 to 8, such LEDs. The LEDs of each light source are preferably arranged in a row, though other arrangements are also possible.

The light generated by the light sources will generally be compliant with regulations and specifications stipulated by the relevant authorities such as the FAA and the ICAO. The white light generated by the white LEDs will generally have a color temperature of between 2750K and 10000K, e.g. between 2750K and 4500K. The red LEDs will generally produce light of wavelength between 620.5 nm and 645 nm.

Suitable LEDs for use in the PAPI unit of the invention are available from Luminus Devices, Inc., 1100 Technology Park Drive—Unit 2, Billerica, Mass. 01821, USA, e.g. the white LEDs available under the product code SST-90W and the red LEDs available under the product code SST-90R.

Light from the light sources is channeled by means of solid waveguides to the intermediate plane. The waveguides are typically of such a shape and size that light is collected efficiently from the light sources, and that the distal (output) faces of the waveguides define an appropriately shaped field in the intermediate plane. In a typical arrangement, in which each light source comprises a row of five LEDs, the individual LEDs are typically arranged on 25 mm centers and so the waveguide typically has a rectangular cross-section, with a width of 125-200 mm and a height (thickness) of 20-30 mm. Thus, the waveguide usually has a width of 100-250 mm, more commonly 125-200 mm, and a thickness of 15-50 mm, more commonly 20-30 mm. The length of the waveguide is not critical, but should be sufficient that the intermediate plane, i.e. the distal face of the waveguide, is fully illuminated by the light propagated through the waveguide. Typically, the waveguide has a length of 100-200 mm, e.g. about 150 mm. Longer waveguides may be used, but at the cost of increasing the overall size of the unit, which may be undesirable.

The waveguides may be of glass, but for reasons of cost the waveguides are preferably formed of synthetic plastics material. The material chosen needs to be sufficiently transmissive to light and to be stable over the operating temperature range of the unit. One suitable plastics material is acrylic. Suitable acrylic waveguides may be prepared by machining of cast acrylic. It is preferred that at least some of the surfaces of the waveguides should be highly uniform, to minimize optical losses. Polishing of the waveguide surfaces may therefore be desirable.

To ensure that the waveguides do not touch and that there is sufficient space to accommodate the light sources and any associated optical components, the waveguides are preferably not disposed parallel to each other, but are slightly angled towards each other. Typically, the angle between the two waveguides is between 0.5° and 4°, e.g. approximately 2°. Because of this, the distal faces of the waveguides are not perfectly coplanar, but the deviation from planarity is so small that it is not significant. To ensure a distinct transition between the red and white sectors, the output faces of the two waveguides are slightly separated, the separation generally being 1 mm or less, more commonly 0.5 mm or less, say 0.05 to 0.5 mm, e.g. about 0.1 mm. In a typical embodiment of the invention, such a gap corresponds to 1 arcminute and so is well within the angle of 3 arcminutes normally specified for the transition between sectors (i.e. from white to red). In practice, it has been found that the edges of the waveguides may be permitted to touch, imperfections in the edges giving an effective separation of an appropriate magnitude.

In order to maximize the performance of the unit, it is important that as much light as possible is channeled from each LED into the associated waveguide. Light from each LED may be directly coupled into the waveguide. Alternatively, a lens may be used to capture light from each LED for coupling into the waveguide. Tapering of the waveguide may also be used to enhance coupling of light from the LEDs.

In the typical arrangement in which the waveguide has a cross-section of approximately 150×25 mm and the light source is made up of a row of five LEDs, as much light as possible from each LED needs to be channeled into an area of about 25×25 mm. This requires an input light cone angle of about 10°, which may be achieved by means of a collimating lens associated with each LED. Such a lens is typically hemispherical in form, which produces a circular input light field. However, as the light is unconfined as it propagates through the waveguide, the light field at the distal face of the waveguide is more uniform. This also has the benefit that the positioning of the LEDs and the collimating lenses is less critical, leading to greater tolerances and hence easier manufacture.

The proximal (input) face of the waveguide may be planar, in which case the light sources (e.g. LEDs) and associated optical components (e.g. collimating lenses) are preferably arranged at angles to the proximal (input) face of the waveguide. For reasons of manufacturing simplicity, however, it is preferred for the light sources and associated optical components to be aligned linearly, transverse to the longitudinal axis of the waveguide. In such a case, the proximal (input) face of the waveguide is preferably faceted, the number of facets matching the number of LEDs. Thus, for instance, where there are five LEDs, the input face of the waveguide has five facets. The central facet is parallel to the output face of the waveguide (and to the row of LEDs), the facets on each side of the central facet are disposed at a first angle to the central facet (typically of the order of 2-5°, e.g. 4°), and the outermost facets are disposed at a second, greater angle (typically of the order of 8-15°, e.g. 10°).

Applicable standards for PAPI systems generally require the intensity profile of the transmitted light beam to satisfy certain criteria. The intensity profile may be modified by some or all of the following measures:

a) The light sources and associated optical elements (e.g. collimating lenses) may be slightly offset from the center of the respective waveguides.

b) Further control of the intensity profile can be achieved electronically, by varying the output of the individual light sources.

c) Imperfections may be introduced into some or all of the surfaces of the waveguides, so as to cause localized optical losses from the waveguides. For instance, some or all of the faces of the waveguide may have roughened surfaces. In one embodiment, where the waveguide has a rectangular cross-section, one major face of the waveguide has a highly polished surface, to minimize optical losses at that surface, while the opposite face and sides are roughened, e.g. by sand-blasting or a similar process.

d) Positioning of an optical diffuser between the light source and part of the proximal face of the associated waveguide.

The projection lens assembly conveys the image in its focal plane (i.e. the light field at the distal (output) faces of the waveguides) into the far field, i.e. in use towards an inbound aircraft. Because the light fields of the two sectors are very close together in the intermediate plane, it is possible to use one projection lens to convey both sectors.

Generally, the diameter of the projection lens will be about 50 mm or more, but should be no more than about 200 mm, e.g. about 150 mm or 120 mm, simply for reasons of cost and compactness. Because simple spherical lenses perform best only at high f-number (the f-number of a lens being the ratio of the focal length to the diameter), the projection lens assembly is preferably a composite lens assembly, most preferably comprising three lens elements. The focal length of the projection lens assembly is preferably in the range 200-400 mm, e.g. about 350 mm.

Because the projection lens inverts the image at the intermediate plane, where (as is conventional) the upper sector of the transmitted light beam is white and the lower sector is red, the image at the intermediate plane must be the converse, i.e. the image at the output face of the upper waveguide is red and that at the output face of the lower waveguide is white.

The light sources (LEDs), associated collimating lenses and waveguides may form part of a sub-assembly that is referred to herein as the “light engine”. That sub-assembly and the projection lens assembly may be mounted on an optical bench with formations that cooperate with the components mounted upon to it facilitate correct alignment and spacing of those components.

The PAPI unit preferably incorporates means for leveling the unit and aiming the output light beam at the correct angle. Most conveniently, the unit is provided with legs that are independently height-adjustable for this purpose.

The PAPI unit according to the invention preferably includes a tilt fault detection system consisting of a tilt switch assembly or a clinometer to indicate any deviation from the proper leveling of the unit.

The PAPI unit preferably includes a weatherproof and corrosion-resistant housing. The unit preferably has a weight and dimensions that are such that it can be lifted and installed in position by a single operator.

In the majority of cases, where the PAPI unit according to the invention is installed permanently at a commercial or military airfield, the unit will be powered by the existing main electricity supply by which landing lights and other electrical equipment associated with the runway are powered. In other circumstances, however, e.g. installation at temporary airfields, the units may be battery-powered, or may be powered by alternative energy sources, such as wind or solar power.

The PAPI unit may comprise a thermostatically controlled heater to prevent ice formation on the lenses.

### BRIEF DESCRIPTION OF THE DRAWINGS

The various features, advantages and other uses of the present apparatus will become more apparent by referring to the following detailed description and drawing in which:

FIGS. 1A and 1B illustrate the principle of operation of a PAPI system;

FIG. 2 is an exploded view of a PAPI unit in accordance with the present invention;

FIG. 3 is an exploded view a light engine forming part of the PAPI unit of FIG. 2;

FIG. 4 is a schematic plan view of the PAPI unit of FIG. 2;

FIG. 5 is a schematic side view of the PAPI unit of FIG. 2;

FIG. 6 shows a first alternative waveguide configuration that could be employed in a PAPI unit according to the invention; and

FIG. 7 shows a second alternative waveguide configuration that could be employed in a PAPI unit according to the invention.

### DETAILED DESCRIPTION

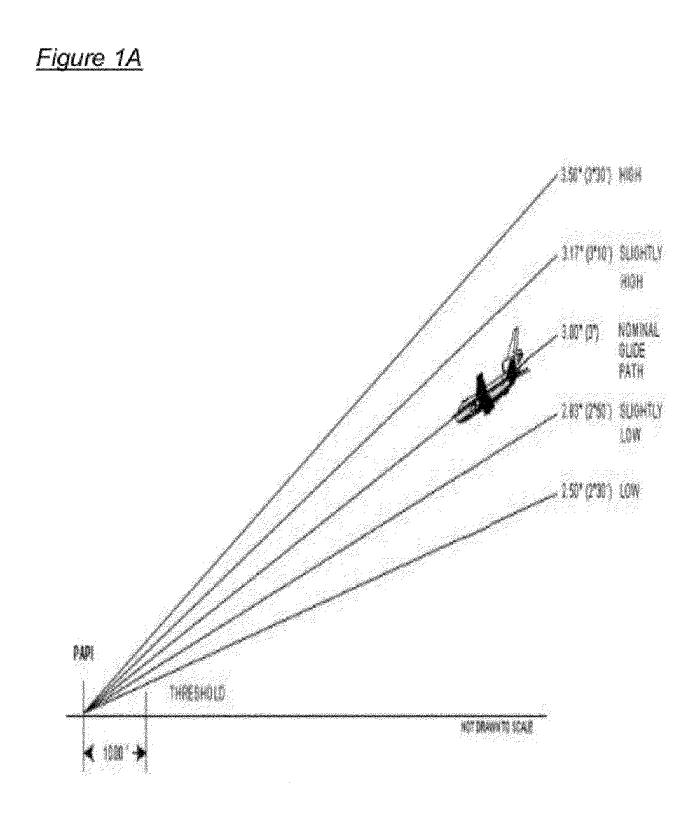

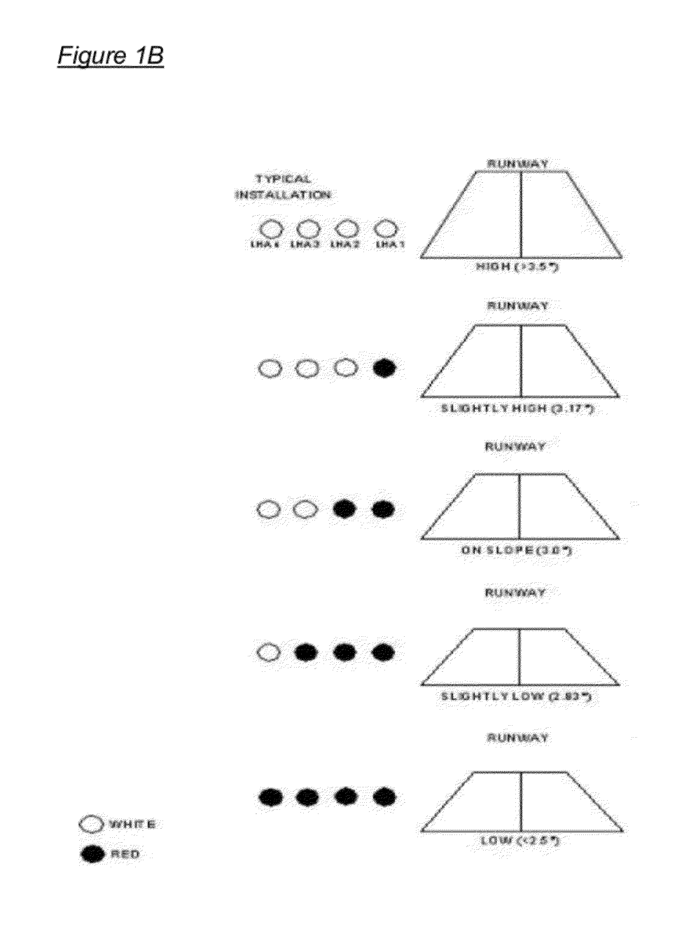

Referring first to the general principle of operation of a PAPI system, FIG. 1(a) shows (schematically and not to scale) an aircraft approaching an airfield runway. The aircraft is shown on its optimal glide angle of 3° to the horizontal, but in practice, without visual guidance, the glide angle may deviate slightly from that optimal value. Such deviations may only be of the order of 0.5° or less, but even such apparently small changes can lead to difficulties in landing the aircraft. This problem is addressed by the PAPI system.

FIG. 1(b) shows schematically a pilot's eye view of such a system. The PAPI system comprises a row of four (or, in the case of an abbreviated PAPI, two) units installed alongside the runway. Each unit emits a horizontally split beam of light, consisting of white light in the upper sector and red light in the lower sector. Two of the units are arranged to transmit at angles slightly greater than the optimal approach angle, and the other two at angles that are slightly smaller than the optimal approach angle. Consequently, when the aircraft is on the correct approach path, the pilot sees two red beams (black circles in FIG. 1(b)) and two white beams (open circles in FIG. 1(b)). This is indicated by the middle representation in FIG. 1(b). If the approach path is too steep, however, the pilot sees three or four white beams (upper representations in FIG. 1(b)); if the approach path is too shallow, the pilot sees three or four red beams (lower representations in FIG. 1(b)).

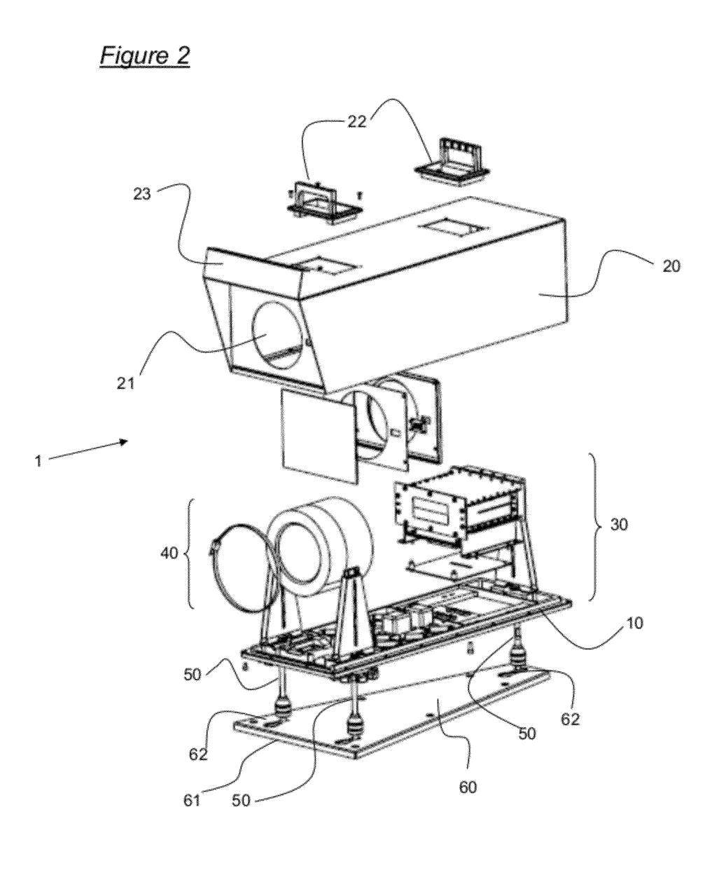

Turning now to FIG. 2, a PAPI unit according to the invention, generally designated 1, comprises a weatherproof enclosure formed from an optical bench 10 and housing shell 20 that is supported by adjustable legs 50. The sides and top of the housing shell 20 project beyond the front wall, to form an overhang which inhibits entry of rain into the interior. The front edge of the top of the housing shell 20 is formed with an upstanding deflection plate 23, the purpose of which is to prevent an approaching pilot seeing light reflected off the top of the unit 1.

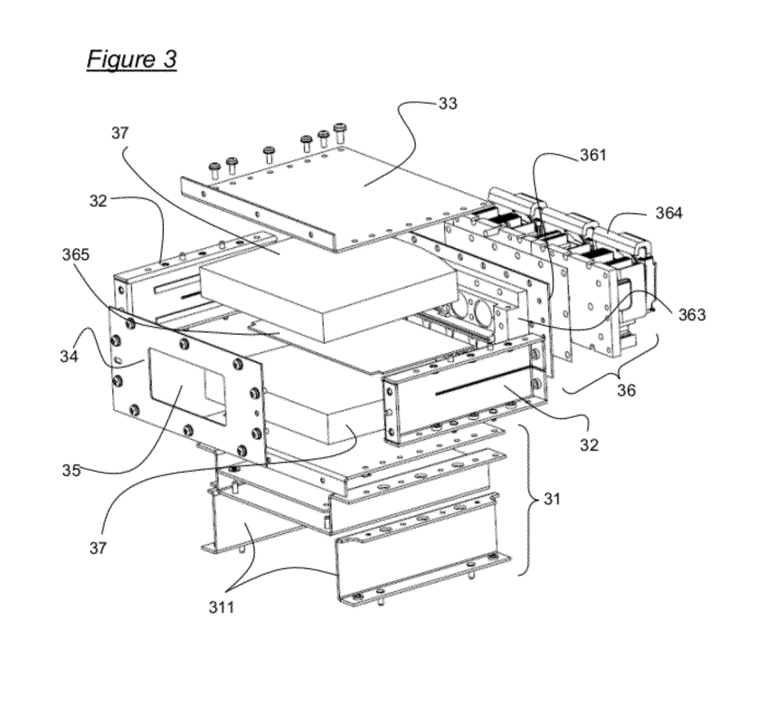

FIG. 2 shows the PAPI unit 1 in exploded form, revealing the following major sub-assemblies, both of which are carried on the optical bench 10:
a “light engine” 30, the structure of which is described more fully with reference to FIG. 3; and
a projection lens assembly 40.

The unit 1 is, in use, engaged with a ground fixing plate 60 that is generally trapezoidal in shape and is intended to be fixed to an appropriate support, typically a concrete pad, alongside an airfield runway, with the front edge 61 of the plate 60 arranged perpendicular to the runway. The plate 60 is formed with keyhole-shaped locating holes 62 for the feet of the legs 50, such that the unit 1 can be engaged with the plate 60 by insertion of the feet into the enlarged forward parts of the holes 62 and pressed backwards. Similarly, the unit 1 can be easily released from the plate 60, e.g. for maintenance. Nonetheless, when engaged with the plate 60, the unit 1 is held securely in a fixed position and orientation.

The housing shell 20 is downwardly open and cooperates with the optical bench 10 to form a substantially fully enclosed housing. The front wall of the housing shell 20 is formed with a circular opening 21 through which, in use, a light beam is emitted from the unit 1. A pair of handles 22 is fitted to the upper wall of the housing shell 20, to facilitate handling of the unit 1, e.g. during engagement with, or disengagement from, the fixing plate 60.

The housing shell 20 encloses two principal sub-assemblies, both of which are carried by the optical bench 10. These sub-assemblies are the “light engine” 30 and the projection lens assembly 40.

The light engine 30 is shown in exploded view in FIG. 3. It comprises a substantially cuboidal box formed from a base assembly 31, side walls 32, a top plate 33, a front plate 34 including an aperture 35 and a rear plate/LED mounting assembly 36. The base assembly 31 includes a pair of spacer plates 311 that are bolted to the mounting base 10.

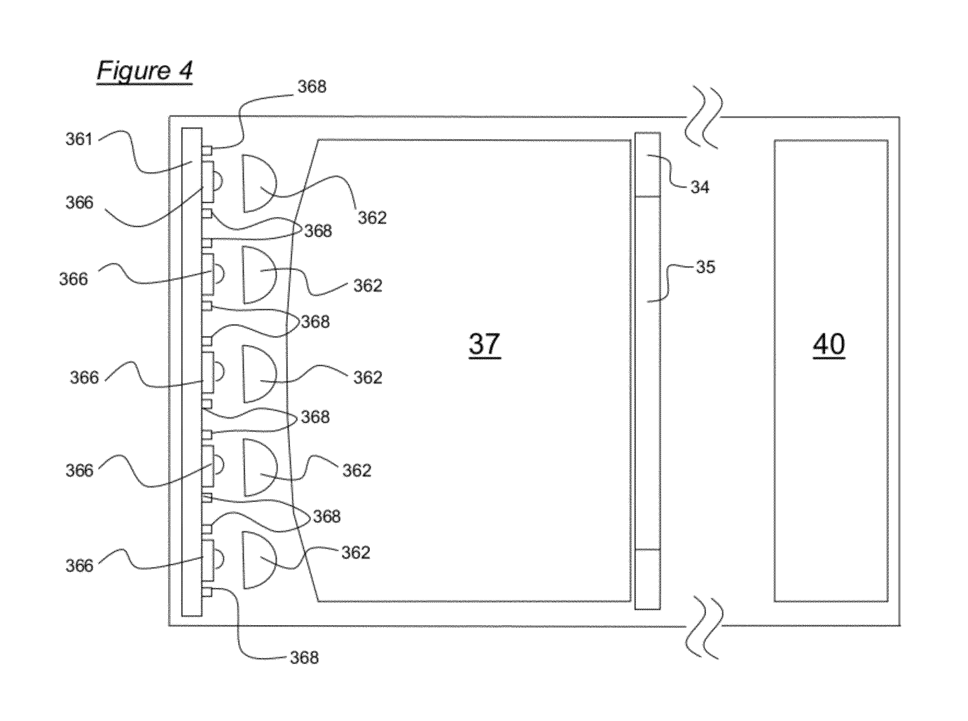

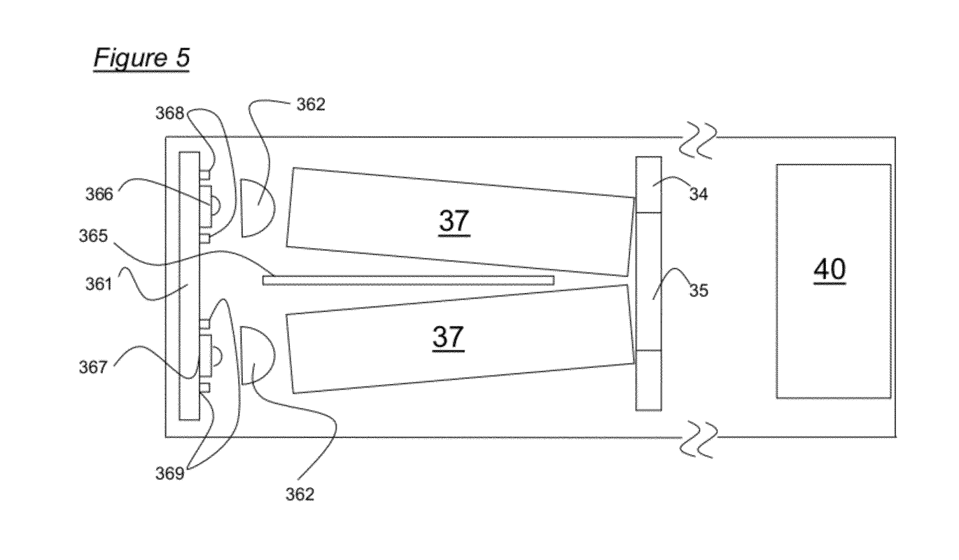

The rear plate/LED mounting assembly 36 includes a printed circuit board (PCB) 361 on which two rows of five light emitting diodes (LEDs; not visible in FIG. 3) are mounted. The upper row of LEDs emit red light, and the lower row emit white light. As is explained below with reference to FIGS. 4 and 5, each LED is associated with a collimating lens 362, each collimating lens 362 being held in a fixed spaced-apart position relative to the LEDs by a lens holder 363. A heat sink 364 with associated fans is mounted behind the PCB 361.

The light engine 30 includes two waveguides 37, one of which is associated with the upper row of (red) LEDs and the other with the lower row of (white) LEDs. The two waveguides 37 are identical and are formed of cast acrylic material. Each waveguide 37 is of rectangular cross-section and is generally cuboidal in form, save that the rear face that is disposed in juxtaposition to the associated collimating lenses has five facets. The central facet is parallel to the front face of the waveguide 37, the facets either side of the central facet are disposed at 4° to the central facet, and the outermost facets at 10° (as is most clearly seen in FIG. 4). The waveguides 37 are approximately 180 mm in width, with a length of approximately 150 mm and a thickness of approximately 25 mm.

For convenience, the upper row of (red) LEDs with their associated collimating lenses 362 and waveguide 37 are referred to herein as the “upper sector” or “red sector” of the light engine 30, and the lower row of (white) LEDs and their associated collimating lenses 362 and waveguide 37 as the “lower sector” or “white sector”.

The lens holder 363 includes a slotted, forwardly-projecting shelf 364 in which is located a divider 365 that is intended to block stray light that might otherwise be transmitted from one sector to another (i.e. between the upper (red) sector and the lower (white) sector).

The construction of the light engine 30 is shown in more simplified fashion in FIGS. 4 and 5. FIG. 4 is a schematic view of the light engine from above, i.e. showing the red sector, and FIG. 5 a similarly schematic view from the side.

FIG. 4 shows the PCB 361 with the upper row of five red LEDs 366, each with an associated collimating lens 362. The collimating lenses 362 are identical and essentially hemispherical. A waveguide 37 is positioned in front of the collimating lenses 362, with the five facets of its rear face in juxtaposition with the collimating lenses.

The arrangement of the lower sector is substantially the same as for the upper sector. As can be seen from FIG. 5, the white LEDs 367 are each associated with a collimating lens 362 and a waveguide 37 is positioned in front of the collimating lenses, as in the upper sector. The divider 365 is positioned between the waveguides 37 and prevents transmission of any stray light from the red sector to the white sector, or vice versa.

Light emitted by the LEDs 366,367 is directed by the collimating lenses 362 onto the rear face of the waveguides 37, and propagates through the waveguides 37 by total internal reflection. The light is allowed to spread unconfined in the transverse direction, which reduces the required tolerances in the positioning of the LEDs 366,367 and of the collimating lenses 362. In the vertical direction, the light is confined by the depth of the waveguide 37, and the length of the waveguide 37 is sufficient that its distal end is illuminated fully and uniformly by the light from the LEDs 366,367. In the illustrated embodiment, the dimensions of the waveguides 37 are approximately 15 cm×18 cm×2.5 cm (length×width×depth).

The LEDs 366,367 and the collimating lenses 362 are slightly offset from the center of the respective waveguides 37, in order to achieve the required intensity profile of the transmitted light beam. Further control of the intensity profile can be achieved electronically, by varying the output of the individual LEDs 366,367. In addition, referring to the upper (as viewed in FIG. 3) waveguide 37, the top surface and each side of the waveguide 37 are roughened by sand-blasting, whereas the other faces are highly polished. This results in greater optical losses at the top and sides of the waveguide, which affects the intensity profile of the light beam at the distal face of the waveguide 37. The lower (as viewed in FIG. 3) waveguide 37 is identical, save that it is the bottom face and sides that are roughened, rather than the top and sides.

To ensure that the waveguides 37 do not touch and that there is sufficient space to mount the collimating lenses 362, the waveguides 37 are not disposed parallel to each other, but are slightly angled towards each other. In FIG. 5, the angle is exaggerated; the angle between the two waveguides is approximately 2°. Because of this, the faces of the waveguides 37 that are remote from the LEDs 366,367 are not perfectly coplanar, but the deviation from planarity is so small that it is not significant and the end faces of the waveguides 37 can be treated as an optical plane. In FIG. 5, a gap is shown between the distal ends of the waveguides 37. Again, that gap is exaggerated in the drawing. In reality, the gap is approximately 100 μm, which corresponds to 1 arcminute and so is well within the angle of 3 arcminutes normally specified for the transition between sectors (i.e. from white to red). In practice, it has been found that the edges of the waveguides 37 may be permitted to touch, imperfections in the edges giving an effective separation of an appropriate magnitude.

The effect of the waveguides 37 is to channel light emitted by the LEDs 366,367 to the optical plane defined by the distal ends of the waveguides 37. That plane is adjacent to the front plate 34 of the light engine 30, which contains the window 35. The shape of the window 35 defines the shape (i.e. the width and height) of the image at the intermediate plane that is transmitted by the projection lens assembly 40.

The optical plane defined by the ends of the waveguides 37 lies in the focal plane of the projection lens assembly 40. The projection lens assembly 40 includes a three component lens of conventional form. The lens has a diameter of 120 mm and a focal length of 350 mm.

In use, the PAPI unit 1 of the invention is used in a similar manner to in which a conventional PAPI unit is used. Briefly summarized, four PAPI units 1 are installed alongside and perpendicular to an airfield runway. Each PAPI unit 1 projects a beam of light that has a white upper sector and a red lower sector. Two of the units 1 are aligned so that the center line of the projected beam is above the optimum glide slope for incoming aircraft, and two are aligned so that the center line of their projected beam is slightly below that glide slope. In the unit 1 of the invention, the light beams are formed by light emitted by the red LEDs 366 and the white LEDs 367 being channeled by their respective waveguides 37 to an intermediate plane defined by the distal ends of the waveguides 37. The image that is formed at that plane comprises a rectangular beam in the upper sector and a rectangular white output beam in the lower sector. That image lies at the focal plane of the projection lens assembly 40, which inverts the image and projects the beams towards incoming aircraft.

A feature of the PAPI unit 1 that has not hitherto been described is the presence of alternative light sources for use at night. These light sources are auxiliary LEDs 368 in the upper sector of the light engine 30 (see FIG. 4) and auxiliary LEDs 369 in the lower sector (see FIG. 5). The auxiliary LEDs emit infra-red light that can be observed with night vision equipment (e.g. night vision goggles). In order to provide the necessary differentiation between the two sectors, the auxiliary LEDs 368 in the upper sector are occulting (i.e. intermittent) whereas the auxiliary LEDs 369 in the lower sector operate continuously.

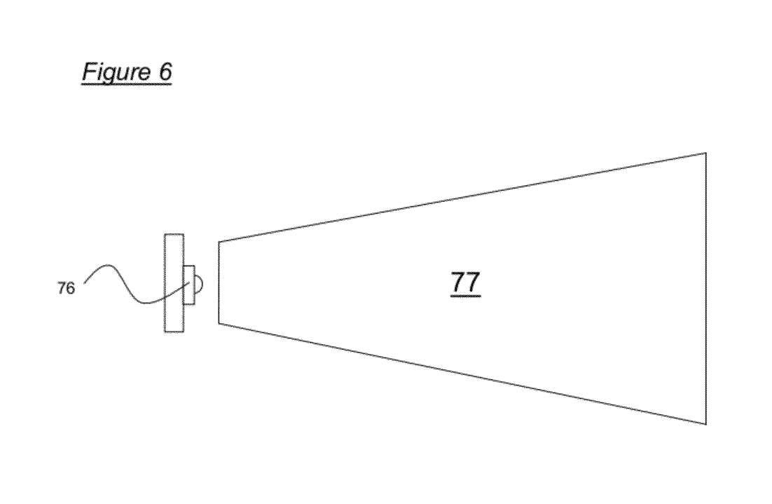

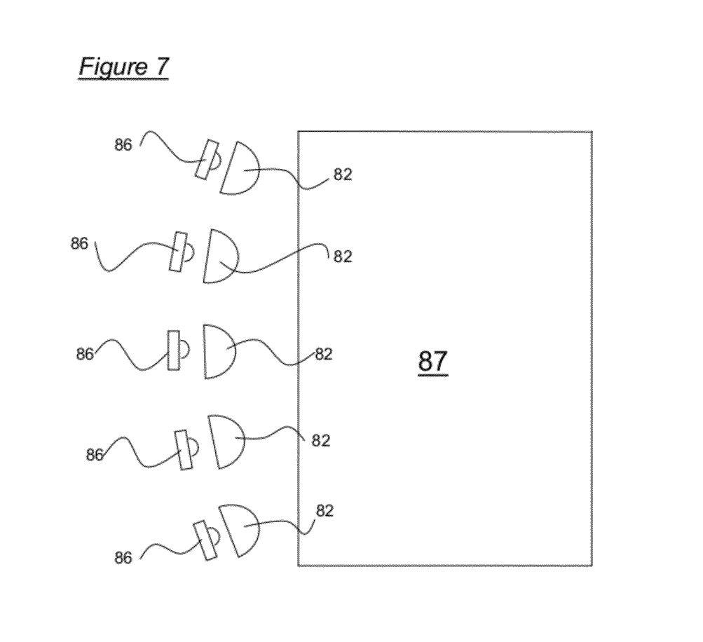

Finally, FIGS. 6 and 7 illustrate waveguide configurations that are alternatives to the waveguide configuration shown in FIGS. 4 and 5, i.e. a configuration in which the LEDs and collimating lenses are positioned linearly and the input face of the waveguide is faceted.

In the arrangement shown in FIG. 6, the waveguide 77 is tapered. The taper acts as an efficient way of reducing the angular output from the LED 76 along the waveguide 77. This works most effectively, the closer the LED 76 can be placed to the input face of the waveguide 77 and therefore the smaller the input face can be. However, LEDs conventionally are fitted with silicone domes that increase the light output of the LED, typically by about 25% for white LEDs and considerably more for red LEDs. This increases the separation of the LED 76 and the input face of the waveguide 77, and hence the required size of the input face. This decreases the efficiency of the tapered waveguide compared to the faceted waveguide of FIGS. 4 and 5. Also, the tapered waveguide 77 requires more complex mountings, and the contact between those mountings and the waveguide 77 itself couples light out of the waveguide and so reduces the amount of light transmitted.

FIG. 7 shows a waveguide 87 with a planar input face, but where the LEDs 86 and associated collimating lenses 82 are arranged at angles to the input face. The central LED 86 and collimating lens 82 are disposed parallel to the input face, but the adjacent LEDs 86 and collimating lenses 82 are disposed at a first angle to the central LED and lens, and the outermost LEDs and lenses are disposed at a second, greater, angle. This arrangement is optically substantially equivalent to that of FIGS. 4 and 5, but is mechanically more complex.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A Precision Approach Path Indicator (PAPI) unit comprising:
a first light source and a second light source;
a first solid waveguide and a second solid waveguide; and
a projection lens assembly, wherein light emitted by the first light source and the second light source is collected by the first solid waveguide and the second solid waveguide respectively and is guided by the first solid waveguide and the second solid waveguide to an intermediate plane, the intermediate plane being located in a focal plane of the projection lens assembly.

2. The PAPI unit as claimed in claim 1, wherein the first light source and the second light source are non-incandescent light sources.

3. The PAPI unit as claimed in claim 2, wherein the non-incandescent light sources comprise light emitting diodes (LEDs).

4. The PAPI unit as claimed in claim 3, wherein the first light source comprises a plurality of red LEDs, and the second light source comprises a plurality of white LEDs.

5. The PAPI unit as claimed in claim 4, wherein the first light source and the second light source each comprise from 4 to 8 LEDs.

6. The PAPI unit as claimed in claim 3, wherein the LEDs of each of the first light source and second light source are arranged in a row.

7. The PAPI unit as claimed in claim 1, wherein the first solid waveguide and the second solid waveguide are each of rectangular cross-section, with a width of 100-250 mm, a thickness of 15-50 mm, and a length 100-200 mm.

8. The PAPI unit as claimed in claim 1, wherein the first solid waveguide and the second solid waveguide are formed of synthetic plastics material.

9. The PAPI unit as claimed in claim 8, wherein the synthetic plastics material is acrylic.

10. The PAPI unit as claimed in claim 1, wherein the first solid waveguide and the second solid waveguide are slightly angled towards each other.

11. The PAPI unit as claimed in claim 10, wherein the angle between the first solid waveguide and the second solid waveguide is between 0.5° and 4°.

12. The PAPI unit as claimed in claim 10, wherein an output face of each of the first solid waveguide and the second solid waveguide are slightly separated by from 0.05 mm to 1 mm.

13. The PAPI unit as claimed in claim 3, wherein a collimating lens is associated with each LED to couple light into the first solid waveguide and the second solid waveguide.

14. The PAPI unit as claimed in claim 13, wherein the LEDs and associated collimating lenses of each of the first light source and the second light source are arranged linearly, transverse to a longitudinal axis of the respective first solid waveguide and second solid waveguide.

15. The PAPI unit as claimed in claim 14, wherein an input face of the first waveguide and the second waveguide is faceted, a number of facets matching a number of LEDs.

16. The PAPI unit as claimed in claim 15, wherein each of the first and second light sources comprises five LEDs, and the input face of each of the first and second solid waveguides has five facets, a central facet being parallel to an output face of the respective first and second solid waveguides, facets on each side of the central facet being at a first angle to the central facet, and outermost facets being at a second, greater angle.

17. The PAPI unit as claimed in claim 1, wherein each of the first light source and the second light source comprises auxiliary light sources that may be visualized using night vision equipment.

18. The PAPI unit as claimed in claim 17, wherein the auxiliary light sources are infra-red light sources, those of the first light source operating continuously, and those of the second light source being intermittent.

19. The PAPI unit as claimed in claim 1, wherein the projection lens assembly is a single projection lens assembly.

20. The PAPI unit as claimed in claim 19, wherein the single projection lens assembly comprises a composite lens.

21. The PAPI unit as claimed in claim 20, wherein the composite lens comprises three lens elements.

22. The PAPI unit as claimed in claim 20, wherein a diameter of the composite lens is from about 50 mm to about 200 mm, and a focal length is from 200 mm to 400 mm.

23. The PAPI unit as claimed in claim 1, wherein output faces of the first solid waveguide and the second solid waveguide lie in the intermediate plane.

24. A PAPI system comprising a plurality of PAPI units according to claim 1.
